(19) United States
(12) Patent Application Publication
(10) Pub. No.: US 2025/0206940 A1
(43) Pub. Date: Jun. 26, 2025

(54) CURABLE EPOXY COMPOSITIONS, STRUCTURAL ADHESIVE THEREFROM, AND METHODS OF USING SAME

(71) Applicant: Henkel AG & Co. KGaA, Duesseldorf (DE)

(72) Inventors: Yuan Zhao, Shanghai (CN); Chris JinFeng Zhong, Shanghai (CN); ChongYu Zhu, Shanghai (CN); Qi Chen, Shanghai (CN); XueWen Zhang, Shanghai (CN)

(21) Appl. No.: 18/920,151

(22) Filed: Oct. 18, 2024

Related U.S. Application Data
(63) Continuation of application No. PCT/CN2022/088112, filed on Apr. 21, 2022.

(51) Int. Cl. C08L 63/00; C08G 59/42; C09J 5/00; C09J 163/00

(52) U.S. Cl. CPC C08L 63/00; C08G 59/4253; C09J 5/00; C09J 163/00; C08L 2205/035; C08L 2207/53

(57) ABSTRACT

This invention relates to a curable epoxy composition comprising an epoxy resin, a core-shell rubber, a capped polyurethane prepolymer, a hardener, a multifunctional epoxy-terminated prepolymer, along with related methods of making and using the same. The curable epoxy compositions could be used as structural adhesives after curing, for example, in automotive industrial bonding applications, which provides very good toughening performance, high low temperature impact peel strength, good water resistance and good corrosion resistance.

### TECHNICAL FIELD

The present disclosure relates to curable epoxy compositions, structural adhesives therefrom, especially impact resistant structural adhesives and assemblies, along with related methods of using the same. The curable epoxy compositions and structural adhesives can be used, for example, in automotive industrial bonding applications.

### BACKGROUND OF THE INVENTION

With the increase in the use of adhesives for both vehicle assembly and vehicle repair. Industry sources have predicted a sustaining structural adhesive market growth annually. During both vehicle assembly and collision repairs, structural adhesives are typically used along with mechanical fasteners or spot welding which is referred to as cold joining using a hybrid joint. The joint is considered a hybrid because it uses both an adhesive and a fastener together. Hybrid joining combines the strengths of both the adhesive and the fastener together to overcome their individual vulnerabilities. Vehicle manufacturers also desire an adhesive that can absorb collision energy as the bonded parts deform during a collision. This requirement for higher performance standards for structural bonding has inspired more adhesive makers to create what they deem impact resistant structural adhesives (IRSA).

IRSA requires the adhesive has comprehensive performance, including shear strength, peel strength, impact peel strength, modulus, tensile strength and good environmental aging performance. The Original equipment manufacturers (OEMs) always apply the adhesive in welding workshop and cure it in paint workshop. Thus, the adhesive needs to match the OEM's production line and has good washing-off resistant as it will go through the pre-treatment line. Due to these requirements, one-component epoxy adhesive is usual a good choice for this application. It has good adhesion strength, good high temperature performance, high modulus. However, traditional epoxy system has a weakness of brittleness, and this will affect the peel and impact peel properties, finally affect the crash test performance and safety result. Thus, toughness is a desired property of epoxy based ISRA system.

Two hotspots in automotive industrial are lightweight and body in white, the material in the body is more and more abundant. Galvanized steel, cold rolled steel, aluminium alloy and composite material are all common materials used. Thus, it requires the adhesives adapt to multi-substrate applications.

### SUMMARY OF THE INVENTION

It is therefore the object of the present invention to overcome the above-mentioned drawbacks by providing a high-performance structural adhesive which combines excellent bonding performance after curing as well as good resistance, in particular, after being exposed to aging or corrosion conditions such as elevated temperatures and increased moisture over a certain period.

It has been surprisingly found that structural adhesive prepared from a curable epoxy composition comprising at least an epoxy resin; a core-shell rubber; a capped polyurethane prepolymer; a hardener and a multifunctional epoxy-terminated prepolymer, provides very good toughening performance, high impact peel strength at low temperature, good water resistance and corrosion resistance.

According to one aspect, the present invention relates to a curable epoxy composition, the curable epoxy composition comprising: A) at least one epoxy resin present in an amount of 10-40 parts by weight; B) a core shell rubber present in an amount of 10-40 parts by weight; C) a capped polyurethane prepolymer present in an amount of 3-15 parts by weight; D) an effective amount of a hardener; E) 5-20 parts by weight of a multifunctional epoxy-terminated prepolymer, wherein the multifunctional epoxy-terminated prepolymer being represented by the following formulas:

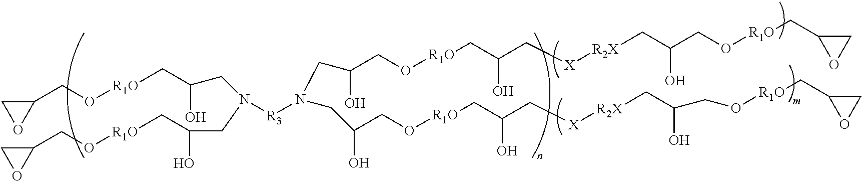

wherein, independently, R₁ being bisphenol A, or bisphenol F, or bisphenol S, or halogenated bisphenol or aliphatic chain having from 1 to 18 carbon atoms; R₂ being one or more selected from the group of polybutadiene, or polyacrylonitrile, or polypentadiene; R₃ being aliphatic chain having from 10 to 400 carbon atoms; X being amine group or ester group; n being 1 to 10; and m being 1 to 10.

According to one aspect, the present invention is directed to a structural adhesive, which is a cured product of the curable epoxy composition of present invention.

According to still another aspect, the present invention also relates to an article comprising a first substrate, a second substrate and a cured composition disposed between and adhering the first substrate and the second substrate, wherein the cured composition is the cured product of the curable epoxy composition of this disclosure.

According to still another aspect, the present invention also relates to an automotive frame, which comprises the article of this disclosure.

In still another aspect, the present invention is directed to a method of using a curable epoxy composition which comprises: applying a curable epoxy composition of at least one of this disclosure on a first substrate, attaching a second substrate to the first substrate, and curing the curable epoxy composition in contact with the first substrate and the second substrate to prepare a composite article.

### BRIEF DESCRIPTION OF THE FIGURE

FIG. 1 is a schematic diagram of Ford Laboratory test apparatus.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “a filler” encompasses embodiments having one, two or more fillers. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

As used herein, the term “cure” refers to exposing to radiation in any form, heating, or allowing to undergo a physical or chemical reaction that results in hardening or an increase in viscosity.

As discussed previously, embodiments of the present disclosure are directed to a curable epoxy composition comprising at least an epoxy resin; a core-shell rubber; capped polyurethane prepolymer; a hardener and a multifunctional epoxy-terminated prepolymer.

### Epoxy Resin

The curable epoxy composition comprises at least one epoxy resin. Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-I-phenyl ethane), bisphenol F, bisphenol K, bisphenol M, tetramethylbiphenol, diglycidyl ethers of aliphatic glycols and polyether glycols such as the diglycidyl ethers of C2-24 alkylene glycols and poly(ethylene oxide) or poly(propylene oxide) glycols; polyglycidyl ethers of phenol-formaldehyde novolac resins, alkyl substituted phenol-formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof.

Commercially available epoxy resins include those sold as DER 331 by Dow Chemical, EPON 828 by Hexion, YD 128 by Kukdo Chemical.

Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure I:

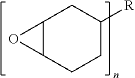

wherein R is an aliphatic, cycloaliphatic and/or aromatic group and n is a number from 1 to 10, preferably from 2 to 4. When n is 1, the cycloaliphatic epoxide is a monoepoxide. Dior epoxy resins are formed when n is 2 or more. Mixtures of mono-, di- and/or epoxy resins can be used. Cycloaliphatic epoxy resins of particular interest are (3,4-epoxycyclohexyl-methyl)-3,4-epoxy-cyclohexane carboxylate, bis-(3,4-epoxy-cyclohexyl) adipate, vinylcyclohexene monoxide and mixtures thereof.

The epoxy resin preferably is a bisphenol-type epoxy resin or mixture thereof with up to 10 percent by weight of another type of epoxy resin. Preferably the bisphenol type epoxy resin is a liquid epoxy resin or a mixture of a solid epoxy resin dispersed in a liquid epoxy resin. The most preferred epoxy resins are bisphenol-A based epoxy resins and bisphenol-F based epoxy resins.

An especially preferred epoxy resin is a mixture of a diglycidyl ether of at least one polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol-A or bisphenol-F, this one having an epoxy equivalent weight of at least 300, preferably from 310 to 600. The proportions of the two types of resins are preferably such that the mixture of the two resins has an average epoxy equivalent weight of from 225 to 400.

In embodiments of the present invention, the curable epoxy composition comprising, at least 10 parts by weight, or at least about 15 parts by weight, or at least about 20 parts by weight of the epoxy resin. In some preferred embodiments, up to about 40 parts by weight, or up to about 30 parts by weight, or up to about 25 parts by weight of the epoxy resin. A preferred amount includes 15-30 parts by weight.

### Core-Shell Rubber

The curable epoxy composition of the present invention comprises core-shell as toughener.

In some embodiments, the core-shell rubber component is a particulate material having a rubbery core.

The rubbery core preferably has a Tg of less than −25° C., more preferably less than −50° C., and even more preferably less than −70° C. The Tg of the rubbery core may be well below −100° C. The core-shell rubber also has at least one shell portion that preferably has a Tg of at least 50° C. By “core,” it is meant an internal portion of the core-shell rubber.

The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is crosslinked. The rubbery core may constitute from 50 to 95%, especially from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally crosslinked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie AG, Munich, Germany, under the trade name Genioperl.

The shell polymer, which is optionally chemically grafted or crosslinked to the rubber core, is preferably polymerized from at least one lower alkyl methacrylate such as methyl methacrylate, ethyl methacrylate or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer is generally between 20,000 and 500,000.

A preferred type of core-shell rubber has reactive groups in the shell polymer which can react with an epoxy resin or an epoxy resin hardener. Glycidyl groups are suitable. These can be provided by monomers such as glycidyl methacrylate.

Examples of commercially available core-shell rubbers include, for example, those sold by Kaneka Corporation under the designation Kaneka Kane Ace, including the Kaneka Kane Ace 15 and 120 series of products, including Kaneka Kane Ace MX 153, Kaneka Kane Ace MX 156, Kaneka Kane Ace MX 257 and Kaneka Kane Ace MX 120 core-shell rubber dispersions, and mixtures thereof. The products contain the core-shell rubber particles pre-dispersed in an epoxy resin, at concentrations of approximately 33% or 25%.

10-40 parts by weight of core-shell rubber may be used. The curable epoxy composition of the invention preferably has a total core-shell rubber content of at least 10 parts by weight, or at least 15 parts by weight, or at least 20 parts by weight, or at least 22 parts by weight. The epoxy adhesive of the invention preferably has a total core-shell rubber content up to 40 parts by weight, or up to 30 parts by weight, or up to 25 parts by weight. A preferred amount includes 15-30 parts by weight.

### Capped Polyurethane Prepolymer

The curable epoxy composition of the present invention comprises capped polyurethane prepolymer could surprisingly improve peel strength, especially low temperature peel strength.

The capped polyurethane prepolymer is prepared from at least one diisocyanate or triisocyanate and from a polymer having terminal amino groups, thiol groups or hydroxyl groups and/or from an optionally substituted polyphenol.

The capped polyurethane prepolymer is an isocyanate-functionalized polyurethane prepolymer in which at least a portion of the isocyanate groups have been reacted or blocked. The isocyanate groups of the prepolymer may be blocked or reacted with any suitable reactant such as an alcohol (e.g., a phenol), oxime, amine, lactam (e.g., caprolactam), acetoacetate, malonate or the like. In some embodiments, “de-blocking” takes place such that the capped polyurethane prepolymer is capable of reacting with other components of the adhesive composition when the composition is cured.

In compositions and methods of the present invention, the capped polyurethane prepolymer preferably presents at least 3 parts by weight, or at least 5 parts by weight, or at least 8 parts by weight. The capped polyurethane prepolymer preferably presents up to 15 parts by weight, or up to 13 parts by weight. One preferred amount is 3-15 parts by weight, or 8-13 parts by weight. When the capped polyurethane prepolymer presents up to 20 parts by weight, it will cause the operation difficulty due to high viscosity.

### Hardener

Any hardener (curing agent) appropriate for a one-component (IK) epoxy adhesive may be used. As is known in the art, a one component epoxy adhesive contains all of the ingredients for the adhesive in a single composition and does not cure until exposed to the appropriate conditions (e.g., heat or radiation), which activates the latent hardener.

The hardener, preferably for a one component adhesive composition, preferably comprises a latent hardener. Any latent hardener that does not cause hardening under ambient conditions (“ambient conditions” meaning, e.g., typical room temperature and normal lighting conditions) may be used. A latent hardener that causes the epoxy adhesive to be curable by application of heat is preferred. Some preferred hardeners include dicyandiamide, imidazoles, amines, amides, polyhydric phenols, and polyanhydrides. Dicyandiamide (also known as DICY, dicyanodiamide, and 1- or 2-cyanoguanidine) is preferred.

Any amount of hardener may be used as appropriate for any particular composition according to the present invention. The effective amount of hardener is preferably at least 1 part by weight, or at least 2 parts by weight, or at least 3 parts by weight, or at least 3.5 parts by weight. The amount of epoxy hardener is preferably up to about 5 parts by weight, or up to about 4 parts by weight. Some preferred amounts include 3.1, 3.3, 3.5 and 3.6 parts by weight.

Examples of commercially available sources of the hardeners are, for example, DYHARD 100 SH from Evonik, OMICURE DDA 5 from Huntsman, AMICURE CG1200 from Evonik.

### Multifunctional Epoxy-Terminated Prepolymer

A cured epoxy composition can be improved by the inclusion of a multifunctional epoxy-terminated prepolymer. This prepolymer combined the hydrophobic chain and hydrophilic chain in one molecular. It is surprisedly found this prepolymer can provide the environmental resistance performance of the cured epoxy composition. The final cured product has high impact peel strength at low temperature, such as −40° C. Moreover, this prepolymer can improve the water and corrosion resistance.

In some embodiments, the multifunctional epoxy-terminated prepolymer, wherein the multifunctional epoxy-terminated prepolymer being represented by the following formulas:

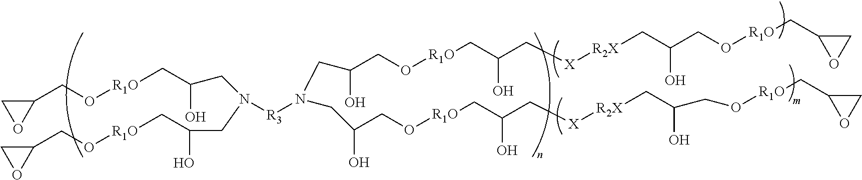

wherein, independently,
R₁ being bisphenol A, or bisphenol F, or bisphenol S, or halogenated bisphenol or aliphatic chain having from 1 to 18 carbon atoms;
R₂ being one or more selected from the group of polybutadiene, or polyacrylonitrile, or polypentadiene;
R₃ being aliphatic chain having from 10 to 400 carbon atoms, or preferred being aliphatic chain having from 40 to 200 carbon atoms;
X being amine group or ester group;
n being 1 to 10, or preferred being 1 to 5; and
m being 1 to 10, or preferred being 1 to 5.

In some embodiments, the multifunctional epoxy-terminated prepolymer is a reaction product of a difunctional epoxy, a rubber dicarboxylic acid or a rubber base diamine, and a polyamine comprising aliphatic chain.

### <The Difunctional Epoxy>

The difunctional epoxy resins have at least about two epoxy groups per molecule. Preferred difunctional epoxy resins include those discussed below.

Any effective amount of polyetheramine-epoxy adduct may be used in the present invention. The epoxy adhesive of the invention preferably has a total polyetheramine-epoxy adduct content of at least 3 wt. %, more preferably at least 5 wt. %, more preferably at least 10 wt. %. The epoxy adhesive of the invention preferably has a total polyetheramine-epoxy adduct content up to 60 wt %, more preferably up to 40 wt. %, more preferably up to 20 wt. %. Some preferred amounts include 10, 15, and 20 wt. %.

### <Rubber Dicarboxylic Acid or Rubber Base Diamine>

The rubber dicarboxylic acid or rubber base diamine comprises a liquid rubber that has epoxide-reactive groups, such as carboxyl or amino groups.

Suitable rubber dicarboxylic acid or rubber base diamine materials are commercially available from Noveon under the tradenames Hypro 2000X162 carboxyl-terminated butadiene homopolymer and Hypro 1300X31 Hypro 1300X8, Hypro 1300X13, Hypro 1300X9 and Hypro 1300X18 carboxyl-terminated butadiene/acrylonitrile copolymers. A suitable amine-terminated butadiene/acrylonitrile copolymer is sold under the tradename Hypro 1300X21.

### <Polyamine Comprising Aliphatic Chain>

The polyamine comprising aliphatic chain comprises a linear amine-terminated polyoxyethylene ether having the following formula:

H₂N—(CH₂)₂—[O—(CH₂)₂—O—(CH₂)₂]ₙ—NH₂
wherein n is 17-27.

The polyamine comprising aliphatic chain also comprises a linear amine-terminated polyoxypropylene ether having the following formula:

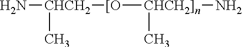

wherein n is 5-100. They are available from Huntsman Chemical under the trade name JEFFAMINE (D-series). The number average molecular weight of the amine-terminated polyoxypropylene ether is, for example, about 300 to about 5000.

The polyamine comprising aliphatic chain further comprises a trifunctional compound with the following formula:

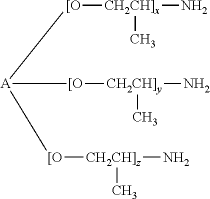

wherein A is:

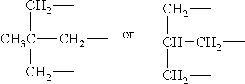

and x, y and z are independently 1-40 and x+y+z is preferably >6. Typical examples of these trifunctional compounds are commercially available from Huntsman Chemical under the trade name of JEFFAMINE (T series). The number average molecular weight of the above-mentioned materials is generally about 300 to about 6000.

The polyamine comprising aliphatic chain also comprises capped polymers of aminosilane, such as those that can be included in the following formula:

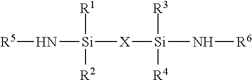

wherein R¹, R², R³ and R⁴ may be the same or different and selected from hydrogen, hydroxy, alkyl, alkoxy, alkenyl, alkenyloxy, aryl, and aryloxy; R⁵ and R⁶ may be the same or different and selected from hydrogen, alkyl, and aryl; and X is selected from alkylene, alkenylene, arylene, with or without heteroatom interruption; polyurethane; polyether; polyester; polyacrylate; polyamide, polydiene; polysiloxane; and polyimide.

For example, amine-terminated siloxanes can be used, such as the diaminosiloxane included in the following formula:

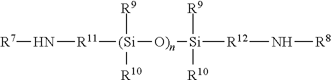

wherein R¹¹ and R¹² may be the same or different and selected from alkylene, arylene, alkylene oxide, arylene oxide, alkylene ester, arylene ester, alkylene amide or arylene amide; R⁹ And R¹⁰ may be the same or different and selected from alkyl or aryl; R⁷ and R⁸ are as defined above, and n is 1-1,200.

This application may use certain amino-modified silicone fluids commercially available from Shin-Etsu under the trade names KF857, KF858, KF859, KF861, KF864, and KF880. In addition, Wacker Silicones commercially provides a series of amino-functional silicone fluids called L650, L651, L653, L654, L655, and L656, as well as amino-functional polydimers under the trade name WACKERFINISHWR 1600 Methylsiloxane.

Other amino-functional silanes or siloxanes used to form adducts include materials purchased from the Sivento branch of Degussa, such as a proprietary amino-functional silane composition (called DYNASYLAN 1126), oligomeric aminosilane system (called DYNASYLAN 1146), N-vinylbenzyl-N′-aminoethyl-e-aminopropyl polysiloxane (DYNASYLAN 1175), N-(n-butyl)-3-amino Propyltrimethoxysilane (DYNASYLAN 1189), proprietary amino-functional silane composition (called DYNASYLAN 1204), N-(2-aminoethyl)-3-aminopropylmethyldimethoxysilane (DYNASYLAN 1411), 3-aminopropylmethyldiethoxysilane (DYNASYLAN 1505), 3-aminopropylmethyldiethoxysilane (DYNASYLAN 1506), 3-aminopropyltriethoxy Silane (DYNASYLAN AMEO), proprietary aminosilane composition (called DYNASYLAN AMEO-T), 3-aminopropyltrimethoxysilane (DYNASYLAN AMMO), N-2-aminoethyl-3-aminopropyl Trimethoxysilane (DYNASYLAN DAMO), N-(2-aminoethyl)-3-aminopropyltrimethoxysilane (DYNASYLAN DAMO-T) and triamino-functional propyltrimethoxysilane (Referred DYNASYLAN TRIAMO).

In compositions and methods of the present invention, the multifunctional epoxy-terminated prepolymer preferably presents at least 5 parts by weight, or at least 5.5 parts by weight, or at least 7 parts by weight, or at least 7.5 parts by weight, or at least 9 parts by weight, or at least 12 parts by weight. The multifunctional epoxy-terminated prepolymer preferably presents up to 20 parts by weight, up to 16 parts by weight, or up to 15.5 parts by weight, or up to 15 parts by weight, or up to 14 parts by weight. One preferred amount is 5-20 parts by weight, or 5-16 parts by weight, or 5.5-15.5 parts by weight, or 7-13 parts by weight.

The curable epoxy composition of the present invention comprises multifunctional epoxy-terminated prepolymer could surprisingly improve corrosion resistance, water resistance and peel strength, especially low temperature peel strength.

### Optional Additives

### Optional Additives Include Epoxy Resin Diluent.

Epoxy resin diluent include a wide variety of epoxy resin compounds. Any epoxy diluent compound that improves the mechanical and thermal performance of the final composition is preferably used as the epoxy resin diluent composition. For example, the epoxy diluents, (or polyepoxides) useful in the present invention may include aliphatic, cycloaliphatic, aromatic, hetero-cyclic epoxy diluents, and mixtures thereof. In one preferred embodiment, the epoxy diluent may contain, on the average, one or more reactive oxirane groups. Epoxy resins useful in the embodiments described herein may include for example mono-functional epoxy resins, multi- or poly-functional epoxy resins, and combinations thereof.

Suitable examples of the epoxy resin diluent useful in the present invention may include, but are not limited to, butyl glycidyl ether (BGE), phenyl glycidyl ether (PGE), cresol glycidyl ether (CGE), benzyl glycidyl ether, p-tert-butylphenyl glycidyl ether, 2-ethyl hexyl glycidyl ether, decyl glycidyl ether, alkyl (C12-C14) glycidyl ether (AGE), polyglycol diglycidyl ether, polypropylene diglycidyl ether, 1,4-butanediol diglycidyl ether (BDDGE), 1,6-hexanediol diglycidyl ether (HDDGE), ethylene glycol diglycidyl ether, neopentane glycol diglycidyl ether, rescorcinol diglycidyl ether, trimethyl propane triglycidyl ether (TMPTGE); and mixtures thereof.

Other examples of the epoxy resin diluent may include commercially available resins such as D.E.R.™ 331, D.E.R. 337, D.E.R. 736 and mixtures thereof. The above D.E.R. epoxy resins are commercial products available from Dow Chemical Company.

Optional additives also include some fillers which could increase the thixotropic, decrease density or keep modulus.

In some embodiments, the composition of the present invention comprises known fillers such as various ground or precipitated chalk, quartz powder, alumina, non-flaky clay, dolomite, carbon fiber, glass fiber, polymeric fibers, titanium dioxide, calcined silica, carbon black, calcium oxide, calcium carbonate, calcium magnesium carbonate, barite, and especially silicate-like fillers of the type of aluminum magnesium silicate calcium, such as wollastonite and chlorite. Generally, the compositions of the present invention may contain from about 5 to about 30 parts by weight of side fillers.

In yet other embodiments, hollow glass bubbles are present in the composition as fillers. Commercially available hollow glass bubbles include materials sold under the trademark SCOTCHLITE by 3M, and suitable grades include those available under the names B38, C15, K20, and VS5500. The hollow glass microspheres preferably have a diameter of about 5-200 microns and/or a density of about 0.3 to about 0.5 g/cc. Generally, the composition may contain about 0.5 to about 5 parts by weight of hollow glass bubbles.

In some embodiments, filler loadings may be at least 10 parts by weight, or at least 20 parts by weight, or at least 30 parts by weight, or at least 40 parts by weight. In some embodiments, filler loadings may be between 5-40 parts by weight, or 10-35 parts by weight.

### Preparing Method of the Curable Epoxy Composition

Methods according to the present invention also include obtaining (e.g., manufacturing; purchasing; mixing components of a 1K curable epoxy composition; etc.) a structural adhesive according to the present invention and exposing the curable epoxy composition to conditions to partially or completely cure the epoxy adhesive composition to form a structural adhesive.

In some embodiments of the present invention, the multifunctional epoxy-terminated prepolymer is preferably prepared by steps of:
a) Mixing the difunctional epoxy and the rubber dicarboxylic acid or rubber base diamine, heating the mixture at 100-150° C. with mixer for 2-5 h.
b) adding polyamine and another difunctional epoxy for another 2-5 h reaction.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector).

### Listing of Embodiments

1. A curable epoxy composition comprising:
   A) at least one epoxy resin present in an amount of 10-40 parts by weight;
   B) a core shell rubber present in an amount of 10-40 parts by weight;
   C) a capped polyurethane prepolymer present in an amount of 3-15 parts by weight;
   D) an effective amount of a hardener;
   E) 5-20 parts by weight of a multifunctional epoxy-terminated prepolymer, wherein the multifunctional epoxy-terminated prepolymer being represented by the following formulas:

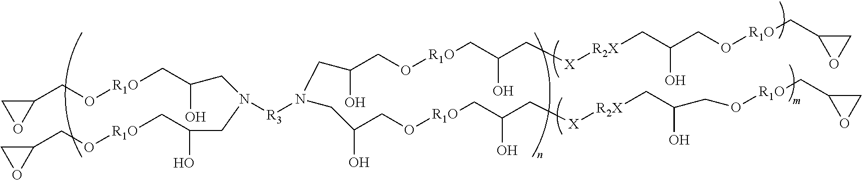

wherein, independently,
R₁ being bisphenol A, or bisphenol F, or bisphenol S, or halogenated bisphenol or aliphatic chain having from 1 to 18 carbon atoms;
R₂ being one or more selected from the group of polybutadiene, or polyacrylonitrile, or polypentadiene;
R₃ being aliphatic chain having from 10 to 400 carbon atoms;
X being amine group or ester group;
n being 1 to 10; and
m being 1 to 10.
2. The curable epoxy composition of embodiment 1, wherein the multifunctional epoxy-terminated prepolymer being represented by the following formulas:

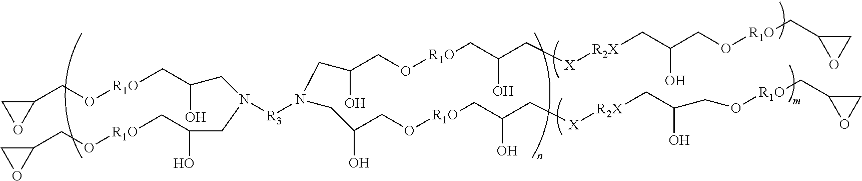

wherein, independently,
R₁ being bisphenol A, or bisphenol F, or bisphenol S, or halogenated bisphenol or aliphatic chain having from 1 to 18 carbon atoms;
R₂ being one or more selected from the group of polybutadiene, or polyacrylonitrile, or polypentadiene;
R₃ being aliphatic chain having from 40 to 200 carbon atoms;
X being amine group or ester group;
n being 1 to 5; and
m being 1 to 5.
3. The curable epoxy composition of any one of preceding embodiments, wherein the at least one epoxy resin is selected from the group consisting of diglycidyl ethers of bisphenol A or bisphenol F.
4. The curable epoxy composition of any one of preceding embodiments, wherein the curable epoxy composition comprises from 15 to 30 parts by weight of said epoxy resin.
5. The curable epoxy composition of any one of preceding embodiments, wherein said core shell rubber has a core comprised of diene homopolymer, diene copolymer or polysiloxane elastomer and/or has a shell comprised of alkyl (meth)acrylate homopolymer or copolymer.
6. The curable epoxy composition of any one of preceding embodiments, wherein the curable epoxy composition comprises 15 to 30 parts by weight of the core shell rubber.
7. The curable epoxy composition of any one of preceding embodiments, wherein said core shell rubber has an average diameter of from 25 to 200 nm.
8. The curable epoxy composition of any one of preceding embodiments, wherein the multifunctional epoxy-terminated prepolymer being a reaction product of:
   a) a difunctional epoxy;
   b) a rubber dicarboxylic acid or a rubber diamine; and
   c) a polyamine comprising aliphatic chain,
   wherein the difunctional epoxy being selected from bisphenol A, or bisphenol F, or bisphenol S, or halogenated bisphenol; the rubber dicarboxylic acid and the rubber diamine, the rubber chain being selected from polybutadiene, or polyacrylonitrile, or polypentadiene; the polyamine comprising aliphatic chain being selected from polyamine having aliphatic chain of 10 to 400 carbon atoms.
9. The curable epoxy composition of any one of preceding embodiments, wherein the curable epoxy composition comprises from 5.5-15.5 parts by weight of said multifunctional epoxy-terminated prepolymer.
10. The curable epoxy composition of any one of preceding embodiments, wherein the capped polyurethane prepolymer is selected from a group consisting of alcohol (e.g., a phenol), oxime, amine, lactam (e.g., caprolactam), acetoacetate, malonate capped polyurethane prepolymer.
11. The curable epoxy composition of any one of preceding embodiments, wherein the curable epoxy composition comprises from 8-13 parts by weight of said capped polyurethane prepolymer.
12. A structural adhesive comprising a cured product of the curable epoxy composition according to any one of preceding embodiments.
13. The structural adhesive of embodiment 12, wherein the structural adhesive has a T-peel of equal to or greater than 8 N/mm, and the T-peel strength remaining equal to or greater than 80% after exposure in 40° C. and 100% RH for 120 hours between the preparing and the curing.
14. The structural adhesive of any one of embodiments 12-13, wherein the cured product has an impact peel strength at minus 40° C. of equal to or greater than 15 N/mm and can pass at least 30 Ford BV 101-07 cycles.
15. An article comprising a first substrate, a second substrate and a cured composition disposed between and adhering the first substrate and the second substrate, wherein the cured composition is the cured product of the curable epoxy composition according to any one of embodiments 1-11.
16. An automotive frame comprises an article of embodiment 15.
17. A method of using a curable epoxy composition which comprises:
   applying a curable epoxy composition of at least one of embodiments 1 to 11 on a first substrate,
   attaching a second substrate to the first substrate, and
   curing the curable epoxy composition in contact with the first substrate and the second substrate to prepare a composite article.
18. The method of embodiment 17, in which at least one of the substrates is metal.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Product name | Description/function | Source |
|---|---|---|
| DER 331 (R1) | Bisphenol A epoxy | DOW chemical (Midland, MI, |
| | | US) |
| XY 207 (R1) | Aliphatic epoxy | Xinyuan chemical (Anhui, |
| | | China) |
| JEFFAMINE D 2000 | Polyamine/di-amine | Hunstman (The Woodlands, |
| (R3) | | TX, Us) |
| JEFFAMINE T 5000 | Polyamine/tri-amine | Hunstman (The Woodlands, |
| (R3) | | TX, Us) |
| PRIAMINE 1074 (R3) | Aliphatic amine/di-amine | Croda (Chino Hills, CA, US) |
| HYPRO1300X13 (R2) | Carboxylated- terminated liquid | Hunstman (The Woodlands, |
| | acrylonitrile rubber | TX, Us) |
| MX 154 | Core-shell rubber epoxy | Kaneka (Osaka, Japan) |
| MX 150 | Core-shell rubber epoxy | Kaneka (Osaka, Japan) |
| MX 257 | Core-shell rubber epoxy | Kaneka (Osaka, Japan) |
| DYHARD UR 700 | accelerant | Evonik (Essen, Germany) |
| DYHARD 100 SH | Hardener | Evonik (Essen, Germany) |
| QR 9466 | capped polyurethane prepolymer | Adeka (Tokyo, Japan) |
| OMYACARB 2 | CaCO₃ | Omya (Shanghai, China) |
| CaO | CaO | Guoyao (Shanghai, China) |
| GARAMITE 7305 | Organophilic phyllosilicates | BYK Chemie (Wesel, |
| | | Germany) |
| NC 513 | Diluent CAS: 68413-24-1 | Cardolite (Zhuhai, China) |
| VS 5500 | Glass bubble | 3M (Saint Paul, MI, US) |

* All raw materials are directly used without any special treatment.

### <Preparation of Multifunctional Epoxy-Terminated Prepolymer>:

For the synthesis of P1, DER 331 (300 g) and CTBN1300X13 (200 g) were added into a reactor. Then the system was heated to 150° C. with the stirring and kept for 3 h. After that, D 2000 (200 g) and DER 331 (300 g) were added into the mixture and were stirred for another 2 h. When the reaction was stopped, the P1 was obtained.

For the synthesis of P5, DER 331 (300 g) and D2000 (200 g) were added into the reactor. Then the system was heated to 120° C. with the stirring and kept for 5 h. When the reaction was stopped, the P5 was obtained.

### Example 1

### <Preparation of Curable Epoxy Composition>

For the preparation of curable epoxy composition E1, DER 331 (25 g), MX 154 (22 g), QR9466 (9 g), P1 (12.5 g) and NC 513 (2 g) were added into a container and mixed by Speedmixer for 1 min at 1000 rpm. Then, UR 700 (0.9 g), 100 SH (3.5 g), VS 5500 (2.2 g), Omyacarb 2 (21 g), CaO (2 g) and Garamite 7305 (1 g) were added into the system and mixed by Speedmixer for 1 min at 1600 rpm for twice, vacuum is needed during mixing.

### <Curing of Curable Epoxy Composition>

The coupons of cold rolled steel (CRS) were washed with acetone and wiped with paper towels, after which 3 g/m² FERROCOTE 61AUS oil was coated on one side. The adhesive was then heat-coated on the oiled surface of the sample. Glass beads (0.25 mm) were sprayed on the adhesive layer before covering the test specimen. The metal clamp is used to clamp the two samples together during the baking cycle. All samples/adhesive assemblies were cured according to the following baking schedule: 45 minutes at 170° C., and 24 hours at room temperature.

The cured structural adhesive samples were subjected to various of tests.

### Example 2-8, and CE1-CE5

The curable epoxy compositions of E2 to E8, CE1 to CE5 were prepared in reference to Example 1. There is no capped PU prepolymer in CE1. There is no multifunctional epoxy-terminated prepolymer in CE2. CE3-CE5 comprise comparative prepolymers. The curable epoxy composition of E2 to E8 and CE1 to CE5 were cured in reference to Example 1. More details are listed in below result part.

### Test Methods

### <Shear Strength>

The sample suitable for the shear test has a 12.5 mm cover and a width of 25 mm and is pulled at a speed of 5 mm/min using an Instron tester. The plateau average load is used to calculate the shear strength.

Shear strength results are recorded and ranked as follows:
Not pass: lower than 20 MPa;
Pass: greater than or equal to 20 MPa;
Good: greater than or equal to 25 MPa;
Excellent: greater than or equal to 30 MPa.

### <T-Peel Strength> and <Room Temperature Impact Peel Strength>

The sample suitable for the t-peel test has a 100 mm cover and a width of 25 mm and is pulled at a speed of 50 mm/min using an Instron tester. The plateau average load is used to calculate the peel strength.

The specimen with the ISO 11343 test geometry (30 mm cover, 20 mm width) used for the impact peel test was subjected to a 90 J impact load at a drop weight speed of 2 m/s. The impact peel strength was measured using an Instron Dynatup 9250HV impact test machine under a steady state average impact load. The specimen is loaded in an environment box with the temperature of 23° C. or −40° C. The experimental results obtained are shown in Table 3.

T-peel strength results are recorded and ranked as follows:
Not pass: lower than 8 N/mm;
Pass: greater than or equal to 8 N/mm;
Good: greater than or equal to 10 N/mm;
Excellent: greater than or equal to 12 N/mm.

Room temperature (23° C.) impact peel strength results are recorded and ranked as follows:
Not pass: lower than 25 N/mm;
Pass: greater than or equal to 25 N/mm;
Good: greater than or equal to 30 N/mm;
Excellent: greater than or equal to 35 N/mm.

### <Low Temperature Impact Peel Strength (−40° C.)>

Low temperature (−40° C.) impact peel strength results are recorded and ranked as follows:
Not pass: lower than 15 N/mm;
Pass: greater than or equal to 15 N/mm;
Good: greater than or equal to 20 N/mm;
Excellent: greater than or equal to 23 N/mm.

### <Water Resistance>

The water resistance test refers to the normal T-peel test. An additional step, 40° C. and 100% RH for 120 hours is added between the coupon preparing and the curing. The T-peel strength remaining (%) is calculated with T-peel strength with aging/T-peel strength without aging*100%. The remaining is equal to or greater than 70% is pass, preferred is equal to or greater than 80%, more preferred is equal to or greater than 85%.

### <Ford BV 101-07 Cycle>

Ford BV 101-07 cycle test refer to Ford Laboratory Test Method (BV101-07-2002), which shows the environmental resistance result of adhesive exposed to environment, especially anti-corrosion properties.

Ford's Arizona's Proving Ground Equivalent (APGE) corrosion test per 1. Submerge the samples in a 5% NaCl solution at 23° C. for 15 mins, 2. Drip dry vertically at 23° C. for 105 mins, 3. Place the samples in the humidity chamber at 50° C. and 90% RH for 22 hrs. Samples are to remain in the 50° C. and 90% environment over the weekends and holidays.

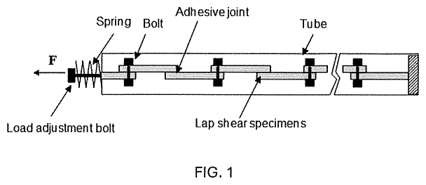

Ford Laboratory Test Method (BV101-07-2002): 6 lap shear test coupons (FIG. 1) are bolted together in an open tube. A static tensile load of 2400N is applied using a compression spring system. Assembly is placed in APGE oven.

The cured epoxy adhesive samples were ranked as “Pass” for the Ford BV 101-07 cycle test when 30 cycles are achieved. Otherwise, the sample was ranked as “Fail”. When the test achieves 45-cycles, the corrosion aging is stopped, and the 45 cycles is the prefer result.

TABLE 1

| Raw material | P1 | P2 | P3 | P4 | P5 | P6 |
|---|---|---|---|---|---|---|
| DER 331 (R1) | 60 | 60 | 60 | | 60 | 60 |
| XY 207 (R1) | | | | 60 | | |
| D 2000 (R3) | 20 | | | 20 | 40 | |
| T 5000 (R3) | | 20 | | | | 40 |
| Priamine 1074 | | | 20 | | | |
| (R3) | | | | | | |
| CTBN 1300X13 | 20 | 20 | 20 | 20 | | |
| (R2) | | | | | | |

Table 1 shows the compositions of 4 multifunctional epoxy-terminated prepolymers (P1-P4) and 1 comparative prepolymers (P5-P6).

The multifunctional epoxy-terminated prepolymers have flexible chain and can be polymerized in the curable epoxy composition. Prepolymers (P1-P4) provide the toughening property to the epoxy structural adhesives.

TABLE 2

| Product | | | | | | | | | | | | | |
|---|---|---|---|---|---|---|---|---|---|---|---|---|---|
| name | E1 | E2 | E3 | E4 | E5 | E6 | E7 | E8 | CE 1 | CE2 | CE3 | CE4 | CE5 |
| DER | 25 | 25 | 25 | 25 | 30 | 40 | 10 | 26.9 | 34 | 35.5 | 25 | 25 | 10 |
| 331 | | | | | | | | | | | | | |
| MX | 22 | 22 | 22 | 22 | 22 | 10 | 40 | 22 | 22 | 23 | 22 | 22 | 40 |
| 154 | | | | | | | | | | | | | |
| QR | 9 | 9 | 9 | 9 | 9 | 13 | 3 | 9 | | 10 | 9 | 9 | 3 |
| 9466 | | | | | | | | | | | | | |
| P1 | 12.5 | | | | 7.5 | 5.5 | 15.5 | 12.5 | 12.5 | | | | |
| P2 | | 12.5 | | | | | | | | | | | |
| P3 | | | 12.5 | | | | | | | | | | |
| P4 | | | | 12.5 | | | | | | | | | |
| P5 | | | | | | | | | | | 12.5 | | 15.5 |
| P6 | | | | | | | | | | | | 12.5 | |
| Dyhard | 0.9 | 0.9 | 0.9 | 0.9 | 0.9 | 0.9 | 0.9 | | 0.9 | 0.9 | 0.9 | 0.9 | 0.9 |
| UR | | | | | | | | | | | | | |
| 700 | | | | | | | | | | | | | |
| Dyhard | 3.5 | 3.5 | 3.5 | 3.5 | 3.5 | 3.5 | 3.5 | 3.5 | 3.5 | 3.5 | 3.5 | 3.5 | 3.5 |
| 100 | | | | | | | | | | | | | |
| SH | | | | | | | | | | | | | |
| VS | 2.2 | 2.2 | 2.2 | 2.2 | 2.2 | 2.2 | 2.2 | 2.2 | 2.2 | 2.2 | 2.2 | 2.2 | 2.2 |
| 5500 | | | | | | | | | | | | | |
| Omya | 21 | 21 | 21 | 21 | 21 | 21 | 21 | 21 | 21 | 21 | 21 | 21 | 21 |
| carb 2 | | | | | | | | | | | | | |
| CaO | 2 | 2 | 2 | 2 | 2 | 2 | 2 | 2 | 2 | 2 | 2 | 2 | 2 |
| Garamite | 1 | 1 | 1 | 1 | 1 | 1 | 1 | 1 | 1 | 1 | 1 | 1 | 1 |
| 7305 | | | | | | | | | | | | | |
| NC | 2 | 2 | 2 | 2 | 2 | 2 | 2 | | 2 | 2 | 2 | 2 | 2 |
| 513 | | | | | | | | | | | | | |

Table 2 shows compositions of the curable epoxy adhesive E1-E8 and CE1-CE5.

TABLE 3

| Test item | E1 | E2 | E3 | E4 | E5 | E6 | E7 | E8 | CE1 | CE2 | CE3 | CE4 | CE5 |
|---|---|---|---|---|---|---|---|---|---|---|---|---|---|
| Shear strength (MPa) | 32 | 33 | 27 | 25 | 33 | 28 | 30 | 25 | 32 | 32 | 32 | 30 | 28 |
| T-Peel strength (N/mm) | 15 | 14 | 12 | 11 | 13 | 10 | 12 | 9 | 10 | 10 | 10 | 12 | 10 |
| Impact peel strength (r.t.) | 35 | 32 | 36 | 30 | 35 | 34 | 37 | 30 | 30 | 30 | 35 | 35 | 35 |
| (N/mm) | | | | | | | | | | | | | |
| Impact peel Strength (−40° C.) | 25 | 21 | 26 | 17 | 20 | 23 | 24 | 16 | 5 | 5 | 22 | 20 | 22 |
| (N/mm) | | | | | | | | | | | | | |
| Water resistance (T-peel | 80 | 85 | 83 | 81 | 76 | 84 | 85 | 80 | 80 | 50 | 50 | 55 | 45 |
| strength remaining % ) | | | | | | | | | | | | | |
| Ford BV 101-07 cycle | 45 | 45 | 45 | 45 | 45 | 45 | 45 | 34 | 22 | 7 | 7 | 10 | 8 |

Table 3 shows testing results of the curable epoxy adhesive E1-E8 and CE1-CE5.

This IRSA focuses on some properties like shear strength, peel strength, impact peel strength, low temperature impact peel strength and good environmental aging performance. And all test after 170° C., 30 mins curing. The substrate is cold rolled steel.

In Examples 1 to 8, the epoxy adhesives were prepared according to the formulations of curable epoxy compositions provided by the present invention. These formulations especially included the specific multifunctional epoxy-terminated prepolymer and capped polyurethane prepolymer. It can be seen that when the contents of the claimed components of the present invention are within certain ranges, they can act synergistically, such that the prepared epoxy adhesives have good low temperature impact peel strength, water resistance and good anti-corrosion aging performance (Ford BV 101-07 cycle).

In Comparative examples 3 to 5, the epoxy adhesives were prepared by a comparative multifunctional prepolymer. The prepared epoxy adhesives don't have desired low temperature impact peel strength, water resistance and anti-corrosion aging performance (Ford BV 101-07 cycle).

What is claimed is:

1. A curable epoxy composition comprising:
A) at least one epoxy resin present in an amount of 10-40 parts by weight;
B) a core shell rubber present in an amount of 10-40 parts by weight;
C) a capped polyurethane prepolymer present in an amount of 3-15 parts by weight;
D) an effective amount of a hardener;
E) 5-20 parts by weight of a multifunctional epoxy-terminated prepolymer, wherein the multifunctional epoxy-terminated prepolymer being represented by the following formulas: 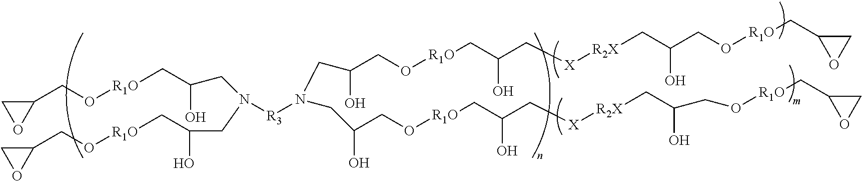
wherein, independently,
R₁ being bisphenol A, or bisphenol F, or bisphenol S, or halogenated bisphenol or aliphatic chain having from 1 to 18 carbon atoms;
R₂ being one or more selected from the group of polybutadiene, or polyacrylonitrile, or polypentadiene;
R₃ being aliphatic chain having from 10 to 400 carbon atoms;
X being amine group or ester group;
n being 1 to 10; and
m being 1 to 10.

2. The curable epoxy composition of claim 1, wherein the multifunctional epoxy-terminated prepolymer being represented by the following formulas: 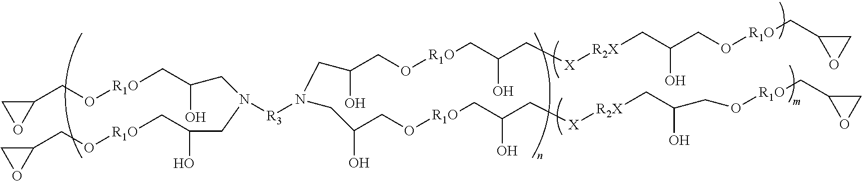
wherein, independently,
R₁ being bisphenol A, or bisphenol F, or bisphenol S, or halogenated bisphenol or aliphatic chain having from 1 to 18 carbon atoms;
R₂ being one or more selected from the group of polybutadiene, or polyacrylonitrile, or polypentadiene;
R₃ being aliphatic chain having from 40 to 200 carbon atoms;
X being amine group or ester group;
n being 1 to 5; and
m being 1 to 5.

3. The curable epoxy composition of claim 1, wherein the at least one epoxy resin is selected from the group consisting of diglycidyl ethers of bisphenol A or bisphenol F.

4. The curable epoxy composition of claim 1, wherein the curable epoxy composition comprises from 15 to 30 parts by weight of said epoxy resin.

5. The curable epoxy composition of claim 1, wherein said core shell rubber has a core comprised of diene homopolymer, diene copolymer or polysiloxane elastomer and/or has a shell comprised of alkyl (meth)acrylate homopolymer or copolymer.

6. The curable epoxy composition of claim 1, wherein the curable epoxy composition comprises 15 to 30 parts by weight of the core shell rubber.

7. The curable epoxy composition of claim 1, wherein said core shell rubber has an average diameter of from 25 to 200 nm.

8. The curable epoxy composition of claim 1, wherein the multifunctional epoxy-terminated prepolymer being a reaction product of:
a) a difunctional epoxy;
b) a rubber dicarboxylic acid or a rubber diamine; and
c) a polyamine comprising aliphatic chain,
wherein the difunctional epoxy being selected from bisphenol A, or bisphenol F, or bisphenol S, or halogenated bisphenol; the rubber dicarboxylic acid and the rubber diamine, the rubber chain being selected from polybutadiene, or polyacrylonitrile, or polypentadiene; the polyamine comprising aliphatic chain being selected from polyamine having aliphatic chain of 10 to 400 carbon atoms.

9. The curable epoxy composition of claim 1, wherein the curable epoxy composition comprises from 5.5-15.5 parts by weight of said multifunctional epoxy-terminated prepolymer.

10. The curable epoxy composition of claim 1, wherein the capped polyurethane prepolymer is selected from a group consisting of alcohol, oxime, amine, lactam, acetoacetate, malonate capped polyurethane prepolymer.

11. The curable epoxy composition of claim 1, wherein the curable epoxy composition comprises from 8-13 parts by weight of said capped polyurethane prepolymer.

12. A structural adhesive comprising a cured product of the curable epoxy composition according to claim 1.

13. The structural adhesive of claim 12, wherein the structural adhesive has a T-peel of equal to or greater than 8 N/mm, and the T-peel strength remaining equal to or greater than 80% after exposure in 40° C. and 100% RH for 120 hours between the preparing and the curing.

14. The structural adhesive of claim 13, wherein the cured product has an impact peel strength at minus 40° C. of equal to or greater than 15 N/mm and can pass at least 30 Ford BV 101-07 cycles.

15. An article comprising a first substrate, a second substrate and a cured composition disposed between and adhering the first substrate and the second substrate, wherein the cured composition is the cured product of the curable epoxy composition according to claim 1.

16. An automotive frame comprises an article of claim 15.

17. A method of using a curable epoxy composition which comprises:
applying a curable epoxy composition of claim 1 on a first substrate,
attaching a second substrate to the first substrate, and
curing the curable epoxy composition in contact with the first substrate and the second substrate to prepare a composite article.

18. The method of claim 17, in which at least one of the substrates is metal.
